(19) United States
(12) Patent Application Publication
(10) Pub. No.: US 2008/0176196 A1
(43) Pub. Date: Jul. 24, 2008

(54) Natural process and new techniques for sterilization

(76) Inventor: G.A. Lee, Reno, NV (US)

Correspondence Address: G.A. LEE, 7630 THOLL DR., Reno, NV, 89506, US

(21) Appl. No.: 12/008,449

(22) Filed: Jan. 11, 2008

Related U.S. Application Data
(60) Provisional application No. 60/881,080, filed on Jan. 18, 2007.

(51) Int. Cl. G09B 19/00

(52) U.S. Cl. 434/219

(57) ABSTRACT

A process for sterilization of clinical environments and which provides a completely sterile and healthy environment for staff and patients alike. The process introduces light to clinical facilities; using the Sun's natural spectrum of U.V. light, (germicidal). More particularly the process includes unique natural sterilization techniques and mixtures including in combination Borax, grapefruit seed extract and colloidal copper/silver, hydrogen peroxide, coconut oil, or the like. More importantly, the process further includes specialized personnel, who are specifically trained in janitorial sterilization, clinical procedures, natural processes, and bio-electromagnetic specialties and/or combinations thereof. Also, the process provides an international health, satellite communication, geo-seismic hazards warning system.

### RELATED PRIOR ART

This application is derived from my provisional application No. 60/881,080 of which was filed on Jan. 18, 2007 in the name of the current inventor. It is to be noted no new material has been entered. The application as presented herein has just been reformatted to comply with PTO regulations.

### FIELD OF THE INVENTION

The present invention relates in general to procedures or processes for sterilization of clinical environments, and for providing a completely sterile and healthy environment for staff and patients alike. Introduce light to clinical facilities; using the Sun's natural spectrum of U.V. light, (germicidal). However, more particularly the process includes unique natural sterilization techniques and mixtures including in combination Borax, grapefruit seed extract and colloidal copper/silver, or the like. More importantly, the process further includes specialized personnel, who are specifically trained in janitorial sterilization, clinical procedures, natural processes, and bio-electromagnetic specialties and/or combinations thereof.

### BACKGROUND OF THE INVENTION

Throughout history man has been constantly fighting illness and trying to develop or discover the secret to extended life and overall good health. The battle is continuous and overwhelming and heretofore has not been successfully resolved. Until recently the health and medical field has not understood that the most life threatening and problematic diseases/illnesses are constantly mutating and quickly adapt to known antibiotics, medical treatments and also germicidal cleansers and the like. Therefore, even though certain products and/or medications were successful in the past they were and are only a temporary solution. To more fully explain the broad range of proposed techniques and/or products for sterilization issues the following prior art is considered to be exemplary.

Currently within the field of germicidal techniques and/or chemical alternatives for cleansing and/or sanitizing the most common substances that are currently recommended include namely, chlorine bleach and ammonia. Unfortunately, these have been in use for far too long and are no longer effective as germs/viruses and the like have become immune and have actually mutated. Bleach and antibiotics no longer have the same effect on most pathogens. More importantly such substances have been clinically proven to be highly dangerous to living creatures, especially man. For confirmation of this, reference is made to material safety data sheets (MSDS), all of which clearly define these substances as being known carcinogens. Therefore, it is extremely important for benefit and preservation of mankind that alternative natural substances be utilized as soon as possible. More importantly we will inform the public and health professionals that use of these substances is dangerous and should be banned accordingly. Until now however, there has not been any known efficient alternative choices that provide appropriate germicidal sanitizing equivalents, especially any substance that is completely natural. With this in mind, the applicant has made numerous experiments and as a result, successfully discovered and has developed a new and natural solution that resolves all of the problems associated with the known prior art. Namely, a solution containing borax, grape fruit seed extract and colloidal copper/silver has proven to be most efficient as a natural germicidal/antiseptic/sanitizer.

In over 100 years of research no germ has ever mutated past any of the techniques, processes, procedures, or solutions we are about to employ. The present composition is an anti-microbial and decontaminates anthrax, pneumococci, straphylococci, streptococci, tuberculi and a variety of fungi, etc. More importantly, borax, grape fruit seed extract and colloidal copper/silver are not carcinogens and are completely safe for use with humans and/or animals. In addition to the above ingredients use of 35% food grade H2O2 (hydrogen peroxide) and 100% cold pressed organic coconut oil will be incorporated for use as antibacterial agents. It is to be noted that each of these substances have been used for different purposes independently but nowhere in the prior art has the applicant found a combination as taught herein.

Within the known prior art, each of these substances have been independently addressed, for example, U.S. Pat. No. 7,135,449 uses grapefruit seed extract but it is only used as a deodorizer. U.S. Pat. No. 6,905,673 uses grapefruit seed extract but it is only used as an oral rinse. U.S. Pat. No. 6,899,903 uses grapefruit seed extract but it is only used as a sinus spray.

U.S. Pat. No. 5,670,470 uses borax but it is only used as a process for stabilizing percarbonate by coating with a coating agent. U.S. Pat. No. 5,366,655 uses borax but it is only used as stable sodium percarbonate particle and the inside of the particle is penetrated and coated with a borate and a process for preparing the same are disclosed. U.S. Pat. No. 4,321,301 uses borax but it is only used as a process for stabilizing particles of peroxygenated compounds by coating by means of a solid coating agent comprises applying a coating agent which contains at least one boron compound from metaboric acid, orthoboric acid and tetraboric acid.

Further exemplary prior art that utilize “colloidal copper/silver” include U.S. Pat. Nos. 7,094,353, 6,890,953, 6,710,017, 6,149,821, and 6,120,698, each of which only pertain to methods of water treatment. Numerous other patents include “colloidal copper/silver” but again none teach, recognize or address the new and unusual end results achieved by the present invention.

### OBJECTS AND ADVANTAGES OF THE PRESENT INVENTION

As previously noted, the present process further includes specialized personnel, who are specifically trained at a new natural, healthy, environmentally friendly safe training facility of which has not previously been proposed. Wherein, the new facility teaches completely new concepts pertaining to janitorial sterilization, clinical procedures, homeopathic techniques and electrical specialties and/or combinations thereof. This is extremely important as the applicant contends that the old teachings are no longer applicable and in fact the old teachings must be eradicated, as they are in fact dangerous and in some cases the old theories are now considered to be life threatening.

With regard to the new teachings associated with the new teaching facility the following exemplify some of the specifics that will be taught. The janitorial sterilization program teaches new sterilizing techniques and teaches why and how the old techniques are no longer desirable. More importantly, the new sterilizing techniques include use of the new cleaning solution as previously described and use of UV light and its properties. Still further numerous sterilizing procedures are to be taught, including new methods for sterilizing the personnel themselves, patients and the surrounding areas, air purification, purification for fabrics, surgical instruments, walls, ceilings, floors, phones, all electrical appliances, equipment, etc. The facility will be adapted to be safe from cross contamination, from patients or practitioners alike. Also the process will introduce the G.R.I.D (Germicidal Retrofit Industrial Door Systems). Namely, a portable system that includes easy to install 4′×2′ sections. The process also includes Argon Gas Generator, (Rife) for energy cell backup so as to be operable during a power outage. Further included is U.V.C. ozone generation, to create the effects of the sun's natural spectrum of germicidal light for natural sanitation of air filtration. To further delete spreading of pathogens from inside the process includes a flow-through, re-circulating vented system.

With regard to the clinical procedures, the technicians will be taught proper procedures for maintaining a sterile environment, handling equipment, food, utensils, napkins, clothing, handling patients, proper patient care, patient evaluation, rife equipment, etc.

With regard to the specialists they will taught all of the above as well as complete natural processes, including, kinesiology, color light therapy, bio-electromagnetics, bio-mechanics, genetics, bio-field technology, U.V light and its properties, vitamin D, diet, nutrition, etc. To name just a few examples as the actual knowledge that will be taught is extensive.

With regard to the specialized electricians they will be taught new electronic technology, including use of the earth and surrounding planet magnetic energies and influences, room analysis including feng shui, all electrical fields and magnetism associated with equipment, lights, etc.

### SUMMARY OF THE INVENTION

It will now be seen the present invention includes numerous advantages, including a novel sanitation composition resultant from ingredients heretofore not combined. Furthermore, the specialized technicians when trained in the subjects and proper use thereof function as a team of specialists. The team will have access to specialized equipment and also a portable room that is designed with all of the factors incorporated. Whereby, the team can be hired by any suitable facility including hospitals, urgent care facilities, individual homeowners, apartment complexes, churches, airports, etc. More importantly, the team can also teach the existing personnel proper procedures and thus provide a completely healthy system, process, method and overall facility that when modified will undoubtedly change the health care system as we now know it. We will all benefit from this application of new clinical sterilization practices.

Furthermore, the current process will correlate data for assessment/risk factors for humans, mammals, internationally with the project hereafter referred to and entitled as S.U.C.C.E.S.S. The process/facility will employ the finest consultants from around the globe to include their studies incorporating data from the geophysical and biological correlations to sun-works, moon-tides, rocks, etc. Further teachings will include how the electrical currents from the sun affect all living bio-systems. Moon tides or gravity, electromagnetic pull, of the moon and how they affect our bio-systems. Rocks and how the above forces work in proportion on the geo-physical world as well. Further included within the process is a plan to formulate a computer based tracking system for collecting remote data in time sensitive logs that tie into our center for data correlation, then to be able to translate data to multiple foreign languages, to form the world's first international health, geo-seismic hazards, satellite communication warning system. With links in all areas of the world, available for broadcast through all communication formats, via internet, public T.V. and radio internationally.

The project S.U.C.C.E.S.S, thus includes information pertaining to solar, U.T.C. (Universal Time Correlation), clinical, earth, science, and studies. The studies include data from the geophysical and biological correlated to sun works, moon tides and rocks. How the electrical currents from the sun affect all living bio-systems, moon tides or gravity, electro-magnetic pull, of the moon, etc.

The project S.U.C.C.E.S.S will be initiated in the spring of 2007 to formulate a computer based tracking system from a location in the Northwestern United States. S.U.C.C.E.S.S will have direct remote date and time sensitive logs that tie into our center for data correlation. To then be able to translate data to multiple foreign languages. Thus, S.U.C.C.E.S.S will provide an international health, satellite communication, Geo-seismic hazards warning system. The resultant free data will save hundreds of lives.

Although the invention has been herein shown and described in what is conceived to be the most practical and preferred embodiments, it is recognized that departures may be made there from within the scope and spirit of the invention, which is not to be limited to the details disclosed herein but is to be accorded the full scope of the claims so as to embrace any and all equivalent devices and apparatus.

What I claim and wish to secure by Letters Patent is:

1. A process/technique that teaches completely new concepts pertaining to janitorial: sterilization, clinical procedures, homeopathic techniques, electrical specialties and/or combinations thereof comprising: said janitorial sterilization includes a new and natural solution containing borax, grape fruit seed extract and colloidal copper/silver of which is a natural germicidal/antiseptic/sanitizer that is suitable as an anti-microbial, said natural solution decontaminates anthrax, pneumococci, straphylococci, streptococci, tuberculi, and a variety of fungi, said solution is not a carcinogen and is completely safe for use with humans and/or animals.

2. The solution of claim 1 further includes 35% food grade H2O2 (hydrogen peroxide) and 100% cold pressed organic coconut oil.

3. The process/technique of claim 1 further includes use of UV light and its properties.

4. The process/technique of claim 1 teaches new sterilizing techniques, why and how the old techniques are no longer desirable, new methods for sterilizing the personnel themselves, patients, surrounding areas, air purification, purification for fabrics, surgical instruments, walls, ceilings, floors, phones, all electrical appliances and equipment.

5. The process/technique of claim 4 is safe from cross contamination, from patients or practitioners.

6. The process/technique of claim 4 further includes a portable system herein referred to as G.R.I.D (Germicidal Retrofit Industrial Door Systems), said portable system includes easy to install 4′×2′ sections, an Argon Gas Generator, (Rife), energy cell backup so as to be operable during a power outage.

7. The process/technique of claim 4 further includes U.V.C. ozone generation, to create the effects of the sun's natural spectrum of germicidal light for natural sanitation of air filtration whereby deleting spread of pathogens from inside said facility via a flow-through, re-circulating vented system.

8. The process/technique of claim 1 wherein said clinical procedures include teaching proper procedures for maintaining a sterile environment, handling equipment, food, utensils, napkins, clothing, handling patients, proper patient care, patient evaluation, rife equipment, etc.

9. The process/technique of claim 8 further includes teaching of complete natural processes, including, kinesiology, color light therapy, bio-electromagnetics, bio-mechanics, genetics, bio-field technology, U.V light and its properties, vitamin D, diet and nutrition.

10. The process/technique of claim 1 further includes specialized electricians who have been taught new electronic technology, including use of the earth, surrounding planet magnetic energies, influences, room analysis, feng shui, all electrical fields, magnetism associated with equipment and lights.

11. The process/technique of claim 1 further includes correlated data for assessment/risk factors for humans, mammals, internationally, a computer based tracking system for collecting remote data in time sensitive logs that tie into said facility for data correlation, translate data to multiple foreign languages, whereby providing the world's first international health, geo-seismic hazards, satellite communication warning system including links in all areas of the world, available for broadcast through all communication formats, via internet, public T.V. and radio internationally.
